(19) United States
(12) Patent Application Publication
(10) Pub. No.: US 2026/0252506 A1
(43) Pub. Date: Aug. 27, 2026

(54) METHOD AND APPARATUS TO RESET COMPONENTS IN A SIDEBAND BUS INTERFACE IN A MEMORY MODULE

(71) Applicant: Intel Products IP LLC, Santa Clara, CA (US)

(72) Inventor: George Vergis, Portland, OR (US)

(73) Assignee: Intel Products IP LLC, Santa Clara, CA (US)

(21) Appl. No.: 19/652,448

(22) Filed: Apr. 20, 2026

Related U.S. Application Data
(63) Continuation of application No. 18/123,218, filed on Mar. 17, 2023.
(60) Provisional application No. 63/440,650, filed on Jan. 23, 2023.

(51) Int. Cl. G06F 13/16; G06F 13/42

(52) U.S. Cl. CPC G06F 13/1673; G06F 13/4282

(57) ABSTRACT

A memory module management controller in a memory module includes a reset controller that monitors a reset signal received from a host memory controller in the host system that is communicatively coupled to the memory module. The memory module management controller includes sideband bus control circuitry. The memory module also includes memory integrated circuits (for example, Dynamic Random Access Memory (DRAM)) and a Registering Clock Driver (RCD). The reset signal from the host memory controller can be time multiplexed, a short duration pulse to indicate reset of the sideband bus control circuitry and a long duration pulse to indicate reset of other components in the memory module, for example, memory integrated circuits and/or Registering Clock Driver (RCD).

### CLAIM TO PRIORITY

This application is a continuation of and claims the benefit of and priority to U.S. application Ser. No. 18/123,218, entitled METHOD AND APPARATUS TO RESET COMPONENTS IN A SIDEBAND BUS INTERFACE IN A MEMORY MODULE, by George Vergis, et al., filed Mar. 17, 2023, now pending, which claims the benefit of and priority to U.S. Provisional Application 63/440,650, by George Vergis, filed Jan. 23, 2023, the entire disclosure of which is incorporated herein by reference.

### FIELD

This disclosure relates to memory modules and in particular to reset of components in a sideband bus interface in a memory module.

### BACKGROUND

A memory module is a printed circuit board on which memory integrated circuits (“chips”) are mounted to another printed circuit board, such as a motherboard, via a connector (also referred to as a “socket”). The connector is installed on the motherboard and a memory module is inserted into the connector. The connector enables interconnection between a memory module and a circuit on the motherboard. A dual in-line memory module (DIMM) has separate electrical contacts on each side of the memory module.

The memory module can communicate with a host system via a sideband bus. The sideband bus may be compatible with the JESD403-1 JEDEC (Joint Electronic Device Engineering Council) Module Sideband Bus standard that is a subset and superset of the MIPI® Alliance I3C Basic^{SM} serial bus standard.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a memory module that includes a plurality of Dynamic Random Access Memory (DRAM) chips;

FIG. 2 is a block diagram of the memory module shown in FIG. 1 including the reset controller in the memory module management controller;

FIG. 3 is a timing diagram illustrating Pulse Width Modulation (PWM) Reset encoding in the memory module management controller shown in FIG. 2 to drive an output reset signal for a short duration to reset sideband bus control circuitry in the memory module;

FIG. 4 is a timing diagram illustrating Pulse Width Modulation (PWM) Reset encoding in the memory module management controller shown in FIG. 2 to drive an output reset signal for a long duration to reset components in the memory module management controller and other devices on the memory module;

FIG. 5 is a block diagram of an embodiment of a system with a memory subsystem including at least one memory module coupled to a memory controller; and

FIG. 6 is a block diagram of an embodiment of a computer system that includes the memory module shown in FIG. 1.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF EMBODIMENTS

A sideband bus that is compatible with the JESD403-1 JEDEC (Joint Electronic Device Engineering Council) Module Sideband Bus standard that is a subset and superset of the MIPI® Alliance I3C Basic^{SM} serial bus standard is a 2-wire interface (clock and data) that lacks a dedicated reset signal.

A host system can reset the sideband bus control circuitry in the memory module by sending a logical ‘0’ on the clock input to the sideband bus control circuitry for a period of time (for example, 25-35 milliseconds). The sideband bus control circuitry interprets the logical ‘0’ on the clock input as a reset command and performs the reset procedure.

Reset decoding on the two-wire interface in the memory module is only effective if the sideband bus control circuitry in the memory module is fully functional, such that the sideband bus control circuitry device can interpret the encoding as a reset signal. However, there are cases where the sideband bus control circuitry is stuck in a state where the reset cannot be decoded, leading to an unrecoverable condition.

The host system can reset other circuitry on the memory module by sending a reset request through a Registering Clock Driver (RCD) to reset components other than the sideband bus control circuitry on the memory module. Recovery from a stuck sideband bus requires a system power cycle. Inability to reset the sideband bus control circuitry on the memory module with a system power cycle results in data loss and downtime.

A memory module management controller in the memory module includes a reset controller that monitors a reset signal received from a host memory controller in the host system that is communicatively coupled to the memory module. The memory module management controller includes sideband bus control circuitry. The memory module also includes memory integrated circuits (for example, Dynamic Random Access Memory (DRAM)) and a Registering Clock Driver (RCD). The reset signal from the host memory controller can be time multiplexed, a short pulse to indicate reset of the sideband bus control circuitry and a long pulse to indicate reset of other components in the memory module, for example, memory integrated circuits and/or Registering Clock Driver (RCD).

The memory module management controller can use the short pulse to reset circuitry contained within itself and the sideband bus control circuitry and propagate the reset to other components in the memory module. The memory module management controller provides power to all of the components on the memory module and can selectively and briefly remove power from a device coupled to the sideband bus, such that a power-down reset of the device in an isolated manner is achieved, hence deterministic reset.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

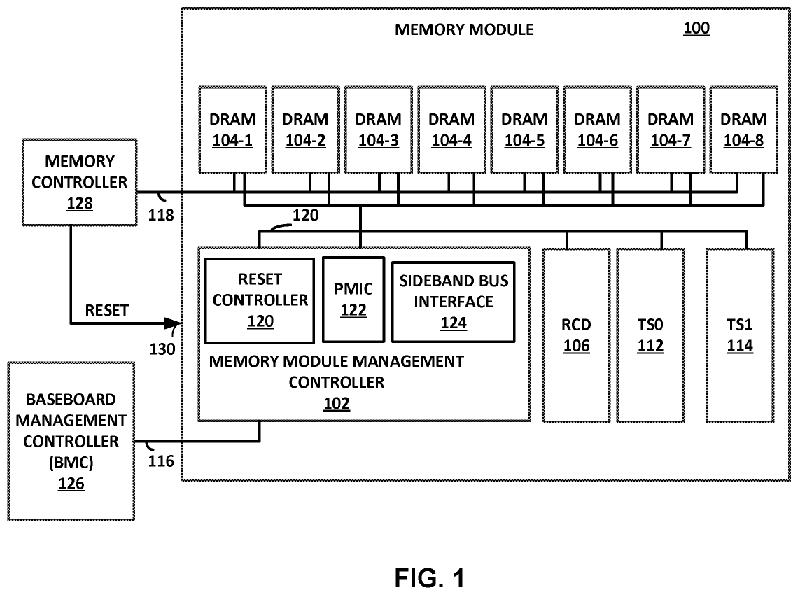

FIG. 1 is a block diagram of a memory module 100 that includes a plurality of Dynamic Random Access Memory (DRAM) chips 104-1, . . . , 104-8. A memory controller 128 in a host system communicates with the DRAM chips 104-1, . . . , 104-8 via a host memory bus, DRAM bus 118.

The memory module 100 communicates with a baseboard management controller (BMC) 126 in the host system via a sideband bus 116. The sideband bus 116 as described herein may be compatible with the JESD403-1 JEDEC (Joint Electronic Device Engineering Council) Module Sideband Bus standard that is a subset and superset of the MIPI® Alliance I3C Basic^{SM} serial bus standard. The BMC 126 is a microcontroller embedded on the motherboard of a system that manages the interface between system-management software and platform hardware.

The memory module 100 has a Registering Clock Driver (RCD) 106 and a memory module management controller 102. The memory module management controller 102 includes a Power Management IC (PMIC) 122, a reset controller 120 and a sideband bus interface 124. The memory module 100 also has two thermal sensors (TS), a first thermal sensor TS0 112 and a second thermal sensor TS1 114, to measure the temperature of the DRAM chips 104-1, . . . , 104-8 on the memory module 100.

In another embodiment, memory module 100 can include a plurality of non-volatile memory integrated circuits or persistent memory integrated circuits, for example, a three dimensional byte accessible non-volatile memory.

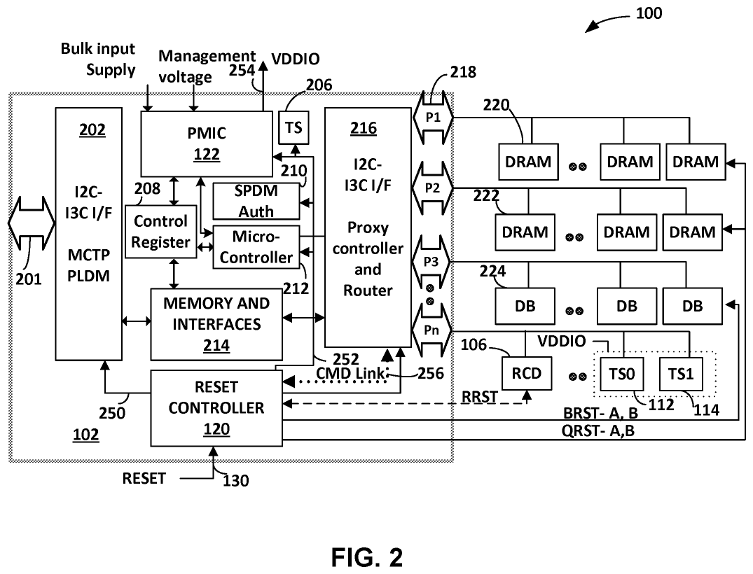

FIG. 2 is a block diagram of the memory module 100 shown in FIG. 1 including the reset controller 120 in the memory module management controller 102. Memory module management controller 102 includes an Input/Output (I/O) port 201, an I2C or I3C interface 202, a PMIC (Power Management Integrated Circuit) 122, a thermal sensor (TS) 206, a control register 208, an SPDM (Security Protocol and Data Model) Authentication engine 210, a microcontroller 212, a memory and interfaces block 214 configured to support a scratchpad, mailbox, Electrically Erasable Programmable Read Only Memory (EEPROM), and operate as Non-volatile memory (NVM) storage in which firmware (FW) certificates are stored. I2C or I3C interface 216 further includes a proxy controller and router coupled to n Input/Output (I/O) ports 218, also labeled P1, P2, P3, . . . Pn. I/O port P1 is connected to multiple DRAMs 220, while I/O port P2 is connected to DRAMs 222. I/O port P3 is connected to data buffers (DBs) 224, while I/O port Pn is connected to a Registered Clock Driver (RCD) 106 and thermal sensor 112 and thermal sensor 114 (also labeled TS1 and TS2).

Memory module management controller 102 communicates with a host (for example, host platform agents in the host) using I2C or I3C protocol via I/O port 201. Under an optional confirmation including a Baseboard Management Controller (BMC) 126, memory module management controller 102 communicates with the BMC 126 via I/O port 201.

The reset signal received on the reset input 130 by the reset controller 120 in the memory module management controller 102 is routed via reset signals 250, 252 within the memory module management controller 102 to provide recovery and/or initialization of its various functional blocks such as the microcontroller 212, SPDM authentication engine 210, thermal sensor (TS) 206, and the proxy controller and router in the I2C or I3C interface 216.

The microcontroller 212 in the memory module management controller 102 is used to flexibly extend the functionality of the memory module management controller 102 compared to a fixed function ASIC and to operate on the data flowing through the memory module management controller 102 (for example, data received on the I3C input on I/O port 201 and send out on the proxy controller output).

The control register 208 is a register file that is configured by the host to configure the functions, behavior, and timing of the memory module management controller 102. As an example, the control register 208 can be programmed by the host controller to delay the output reset to the DRAM (QRST) by a fixed amount relative to the data buffer reset (BRST). All internal and external signal timing and voltage levels can be programmed in the control register in the memory module management controller 102. The host can also program the control resister 208 with a temperature threshold for the memory module management controller 102 to notify the host of critical temperature event based on the value read from the thermal sensor (TS) 206.

Routing the reset signal 250, 252 through the memory module management controller 102 that produces power for all of the I2C or I3C interface 202 and the I2C or I3C interface 216 on the memory module 100 provides the sideband interface (I2C or I3C interface 202 and I2C or I3C interface 216) and all its devices (RCD 106, TS0 112, TS1 114) a deterministic reset capability. The reset signal 250, 252 is not only used to recover the memory module management controller 102 when it becomes unresponsive, but also to control output power (VDDIO) 254 on the memory module management controller 102 such that the sideband devices (for example, RCD 106, TS0 112, TS1 114) powered by output power (VDDIO) 254 are power cycled into their initial state. Conveniently, the memory module management controller 102 includes the reset controller 120 for the memory module 100.

The reset controller 120 in the memory module management controller 102 can assert (trigger) the reset signal 250, 252 in response to an Asynchronous DDR reset signal from the memory controller 128 received on a reset input 130 or an I3C command directed reset 256 from the I2C or I3C interface 216. Upon receiving the reset signal on the reset input 130 or the I3C command directed reset 256, the memory module management controller 102 initiates the reset procedure on its outputs. The memory module management controller 102 has dedicated output signals per component groups categorized by their functionality such as RCD 106, data buffers 224 and DRAMs 220, 222. For sideband devices such as thermal sensors TS0 112 and TS1 114 that do not have a dedicated reset pin, the memory module management controller 102 briefly suspends power (VDDIO) to achieve the effect of reset (power cycling). Irrespective of how the memory module management controller 102 receives the reset signal input, it outputs the reset to the target devices as directed by the host.

The DRAMs 220, 222 and the data buffers 224 on the memory module 100 can be organized into multiple sub-channels. There can be a dedicated reset signal per sub-channel. The dedicated reset signal per sub-channel reduces electrical loading on each output reset signal, provides the ability to reset one sub-channel, and to sequence the reset groups to reduce instantaneous power during initialization. The output reset signal may be further grouped (example: per rank) to allow reset within even smaller logical units in the DRAM 220, 222.

In a memory module 100 in which the RCD 106 uses I2C/I3C commands to reset data buffers 224, the RCD 106 sends an RCD Reset (RRST) signal to the MEMORY MODULE MANAGEMENT CONTROLLER 102 that indicates the reset event. Upon receiving reset event notification, the memory module management controller 102 asserts the Buffer Reset (BRST) signal (the reset signal to the buffers 224). The RCD reset signal RRST is a bi-directional signal used to notify the memory module management controller 102 of the reset event by the RCD 106. Upon the assertion (triggering) of the RRST by the RCD 106, the memory module management controller 102 drives the BRST signal to reset the buffers 224.

In the illustrated embodiment, I2C or I3C interface 202 employs the Management Component Transport Protocol (MCTP). MCTP is a protocol designed by the Distributed Management Task Force (DMTF) to support communications between different intelligent hardware components that make up a platform management subsystem, providing monitoring and control functions inside a managed computer system. MCTP, which is independent of the underlying physical bus or link structure, may also be used for other types of sideband buses and links in addition to I2C or I3C, such as but not limited to SMBus (System Management Bus).

In addition to logic to support a scratchpad, mailbox, EEPROM, NVM storage, memory and interfaces block 214 also includes various interfaces to communicate with I2C or I3C interface 202, control register 208, microcontroller 212, and I2C or I3C interface 216. Memory and Interfaces block 214 can include volatile memory (for example, Dynamic Random Access Memory (DRAM), Static Random Access Memory (SRAM)) in addition to non-volatile memory in some embodiments. Microcontroller 212 is configured to communicate with memory and interfaces block 214, control register 208, PMIC 122, and proxy controller and router in the I2C or I3C interface 216. Microcontroller 212 is illustrative of a processing element with one or more cores or other means for executing instructions such as firmware instructions that may be stored in non-volatile memory in memory and interfaces block 214. Microcontroller 212 also can include pre-programmed logic (for example, Application Specific Integrated Circuit (ASIC circuitry) to perform one or more dedicated functions. Memory module management controller 102 can also act as a proxy controller and mailbox for a target device on the memory module such that microcontroller 212 can initiate autonomous functions such as memory channel training, configuration, calibration, etc. Such autonomous function can help accelerate the boot time as all the memory modules in the platform can simultaneously initialize, in contrast to the existing memory subsystem's reliance on platform Basic Input/Output System (BIOS) to sequentially initialize each memory module.

The integration of multiple function into a single component allows for more flexible internal bussing between the devices with a common control register 208, microcontroller programmable sequence, and shared volatile and non-volatile memory space for code and data. Integration saves space on the memory module, reducing component cost and validation resources.

The microcontroller programmability allows rapid deployment compared to fixed function as well as end user customization. Fixed function logic, as currently exists in memory modules, has numerous interoperability and spec compliance issues throughout the industry. With the use of microcontroller 212, industry standardization and rapid deployment can be achieved. The programmability can be applied to the I3C control plane, PMIC switching regulator parameters, power ramp rate, in-band interrupt notifications etc., which were all previously performed using fixed function logic. Microcontroller 212 also can assist and execute autonomous backside training algorithms with the help of RCD and DRAM devices.

The firmware associated with microcontroller 212 may introduce security concerns. However, mutual authentication facilitated by SPDM authentication engine 210 allows the host to customize the memory module functionality without compromising security—only authenticated platforms can reprogram the microcontroller firmware. The security concern can be alleviated by precluding in-system firmware updates; in this case, the device can only be programmed in a test environment with special high voltage fuse programming (legacy behavior).

Additionally, memory module management controller 102 integrates an addressable I3C router such that the multiple copies of the bus outputs can be used to connect numerous devices such as 80 or more DRAMs 220 without loading the existing single bus down. Integration allows multiple I/O ports to be controlled and arbitrated with microcontroller 212. The individual I/O ports have access to the shared resources, both volatile and non-volatile memory. Each copy of the bus (I/O ports 218) is independently addressed through the built-in router in proxy controller and router in the I2C or I3C interface 216. Effectively this device can work as a 1 in, N out or N in, 1 out router (bi-directional). On the host side of the interface (or on the port side), in one embodiment the MCTP protocol is used to select (route to) I/O ports 218. However, the MCTP packets can be decoded but not routed to the port side, through the device configuration registers. Additionally, Platform Level Data Model (PLDM) over MCTP and SPDM over MCTP protocol can be supported, either on the host or the port-side interfaces.

The memory module management controller 102 can use higher layer protocols such as MCTP and PLDM to allow the memory module management controller 102 to be interconnected and participate within a network of other platform management devices. Both MCTP and SPDM protocols are layers above the I2C or I3C interface. The SPDM (Security protocol and data model) authentication engine 210 allows the host to securely access and invoke functions within the memory module management controller 102. SPDM protocol is used to authenticate the component that manages the memory module management controller 102 through a unique security certificate exchange. The security certificate exchange is used to ensure the authenticity and the right of the memory module management controller 102 to invoke functions such as DRAM, RCD, or DB (data buffer) reset. Other sensitive configuration within the memory module management controller 102 is handled through the SPDM security protocol.

Memory module management controller 102 can also be used on the platform with appropriate firmware modifications such that it can replace the motherboard I/O VR as well as provide I3C routing between the BMC, the host, and the memory module. Doing so allows either the BMC or the host to become the bus master for the memory modules. Existing customer implementations entail use of a multiplexer (MUX) in the platform, to support multi-controller access of the memory module. However, these multiplexers do not scale to higher speeds and do not support dynamic bus sharing. Memory module management controller 102, through use of MCTP packet switching, allows dynamic switching between controllers as well as target devices.

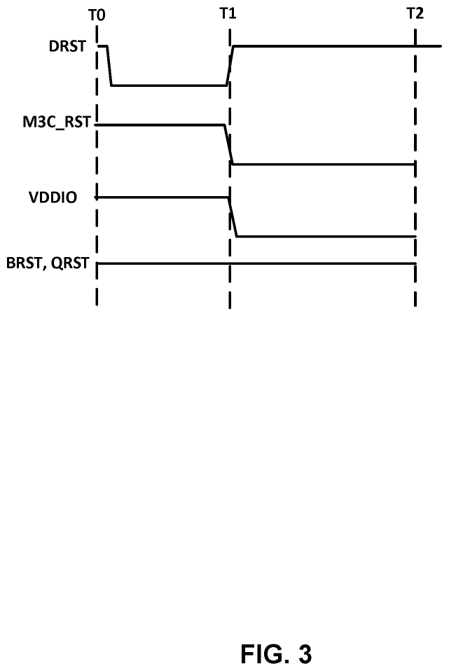

FIG. 3 is a timing diagram illustrating Pulse Width Modulation (PWM) Reset encoding in the memory module management controller 102 shown in FIG. 2 to drive an output reset signal for a short duration to reset sideband bus control circuitry in the memory module.

Additional reset enhancements are evoked by a special register setting, as configured in the control register 208 in the memory module management controller 102.

In the enhanced mode, the host can drive an output reset signal for a short duration (a reset pulse) on the reset input 130 (also referred to as DRST (DDR reset input)) which is interpreted by the memory module management controller 102 as a self-reset of internal blocks in the memory module management controller 102, including sideband interfaces (I2C or I3C interface 202, and I2C or I3C interface 216).

For example, the reset pulse in time period T0-T1 can be a 5 millisecond (ms) pulse on the DRST (DDR reset) input to execute internal reset in memory module management controller 102, as indicated by the Memory Module Management Controller Reset (M3C_RST) signal in FIG. 3. After the internal reset command is registered by the memory module management controller 102, the pre-programmed control register value in control register 208 determines the duration of the internal reset on reset signals 250, 252. The internal reset also entails briefly interrupting the power (VDDIO 254) to the external sideband devices (for example, TS0 112, TS1 114) for the time period T1-T2 as programmed in the control register 208 in the memory module management controller 102.

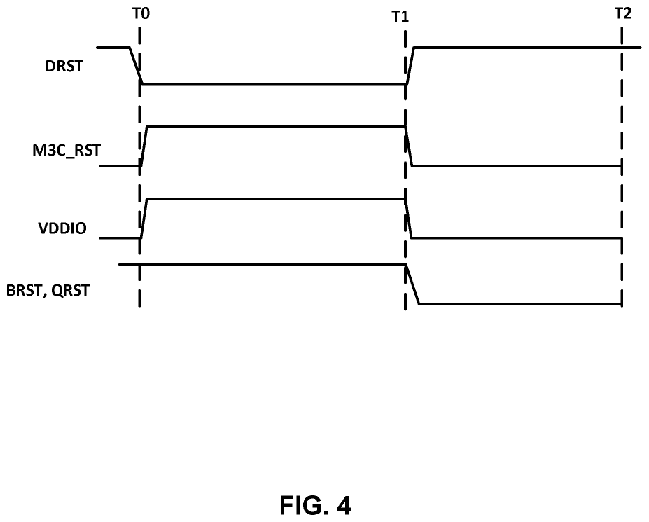

FIG. 4 is a timing diagram illustrating Pulse Width Modulation (PWM) Reset encoding in the memory module management controller shown in FIG. 2 to drive an output reset signal for a long duration to reset components in the memory module management controller 102 and other devices on the memory module 100.

The host can drive an output reset signal for a long duration (a reset pulse) on the reset input 130. The long duration is longer than the short duration to reset sideband bus control circuitry in the memory module 100. The long duration reset pulse on the reset input 130 indicates full memory module reset (DDR reset) that resets all components on the memory module 100, including the execute memory module management controller 102 reset by the short reset pulse, as shown in FIG. 3.

For example, the reset input 130 (DDR reset (DRST)) can be asserted for a T1 to T2 duration of 30 milliseconds (ms) by the host to indicate a full memory module reset command. The value programmed in the control register 208 corresponding to DDR reset (DRST) duration modulates the time threshold at which the full memory module reset command is executed, independent of the T1 to T2 duration of the reset pulse. The host can hold the reset signal on the reset input 130 (DRST) for 30 ms, but the memory module management controller 102 can execute the reset of the full memory module management controller 102 for 25 ms if that is the value that is programmed in the control register 208. The control register 208 can also be programmed to indicate the duration time T1 to T2, which corresponds to how long the data buffer reset (BRST) and the DRAM reset (QRST) (also referred to as a memory reset signal) must be held. Typically, the T1 to T2 duration can be about 50 ms.

The deterministic reset for all components on the memory module provides hardware fault recovery without forcing a complete system power cycle. By moving reset functionality from the RCD 106 to the memory module management controller 102, pins that were used for reset functionality by the RCD 106 can be used for other highspeed signals such as clocks. Power-on reset state to components in the sideband bus interface is provided without use of a dedicated reset pin.

An alternative to using PWM logic to decide whether the reset is exclusively for memory module management controller 102 or the devices that the memory module management controller 102 targets to reset is to use a configuration setting within the memory module management controller 102. With the two configuration options, the configuration of the memory module management controller 102 can default to “legacy mode” (Reset-block=0) in legacy platforms to propagate the DDR Reset (DRST) to all devices on the memory module 100 as in the traditional method. An alternate configuration in a platform that comprehends advanced capabilities of the memory module management controller 102 can result in the memory module management controller 102 using the DRST to reset only the memory module management controller 102, thus requiring a sideband command over the sideband bus 116 to target reset to devices other than the memory module management controller 102. The configuration bit can be set to block (Reset-block=1), such that the DRST will not propagate outside the memory module management controller 102, meaning that the DRST signal is exclusively for the memory module management controller 102 itself. In this case, resetting devices other than the memory module management controller 102 can only be accomplished over the sideband bus 116, using software (or BIOS) commands. With the software commands, there may be situations in which the sideband bus or the memory module management controller 102 is not responding; then the DRST signal can be used to recover the same unresponsive memory module management controller 102 and its associated sideband bus 116. Once the memory module management controller 102 and its associated bus recovers from the stuck condition, a software method can be used to issue reset over the sideband bus 116.

| Reset-Block | Reset behavior | Comments |
|---|---|---|
| 0 (Default behavior) | Propagate | Used for legacy platforms |
| 1 (Must be set | memory module | Used on platforms that |
| explicitly) | management controller | comprehend memory |
| | blocks propagation | module management |
| | | controller features |

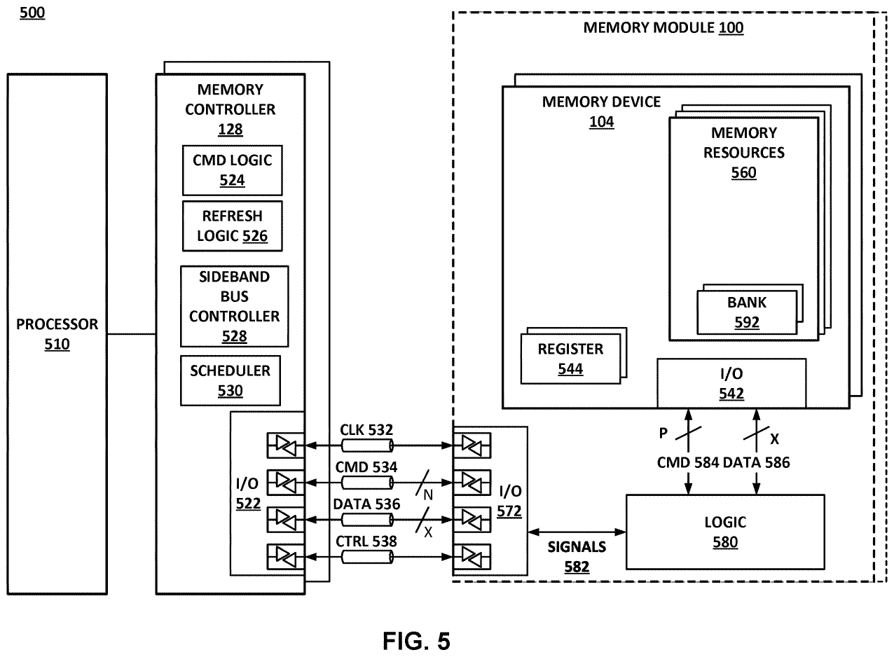

FIG. 5 is a block diagram of an embodiment of a system 500 with a memory subsystem including at least one memory module 100 coupled to a memory controller 128. System 500 includes a processor 510 and elements of a memory subsystem in a computing device. Processor 510 represents a processing unit of a computing platform that can execute an operating system (OS) and applications, which can collectively be referred to as the host or user of the memory. The OS and applications execute operations that result in memory accesses. Processor 510 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or storage controller. Such devices can be integrated with the processor in some systems (for example, in a System-on-Chip (SoC)) or attached to the processer via a bus (e.g., PCI express), or a combination.

Reference to memory devices can apply to different memory types. Memory devices often refers to volatile memory technologies. Volatile memory is memory whose state (and therefore the data stored on it) is indeterminate if power is interrupted to the device. Dynamic volatile memory requires refreshing the data stored in the device to maintain state. Nonvolatile memory refers to memory whose state is determinate even if power is interrupted to the device.

One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, originally published in September 2012 by JEDEC), DDR5 (DDR version 5, originally published in July 2020), LPDDR3 (Low Power DDR version 3, JESD209-3B, August 2013 by JEDEC), LPDDR4 (LPDDR version 4, JESD209-4, originally published by JEDEC in August 2014), LPDDR5 (LPDDR version 5, JESD209-5A, originally published by JEDEC in January 2020), WIO2 (Wide Input/Output version 2, JESD229-2 originally published by JEDEC in August 2014), HBM (High Bandwidth Memory, JESD235, originally published by JEDEC in October 2013), HBM2 (HBM version 2, JESD235C, originally published by JEDEC in January 2020), or HBM3 (HBM version 3 currently in discussion by JEDEC), or others or combinations of memory technologies, and technologies based on derivatives or extensions of such specifications. The JEDEC standards are available at www.jedec.org.

Descriptions herein referring to a “RAM” or “RAM device” can apply to any memory device that allows random access, whether volatile or nonvolatile. Descriptions referring to a “DRAM” or a “DRAM device” can refer to a volatile random access memory device. The memory device or DRAM can refer to the die itself, to a packaged memory product that includes one or more dies, or both. In one embodiment, a system with volatile memory that needs to be refreshed can also include nonvolatile memory.

A non-volatile memory (NVM) device is a type of memory whose state is determinate even if power is interrupted to the device. In one embodiment, the NVM device may include block or byte-addressable, write-in-place memories. Examples may include, but are not limited to, single or multi-level Phase Change Memory (PCM) or phase change memory with a switch (PCMS), non-volatile types of memory that include chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other types of block or byte-addressable, write-in-place memory.

Memory controller 128 represents one or more memory controller circuits or devices for system 500. Memory controller 128 represents control logic that generates memory access commands in response to the execution of operations by processor 510. Memory controller 128 accesses one or more memory devices 104. Memory devices 104 can be DRAM devices in accordance with any referred to above. Memory controller 128 includes I/O interface logic 522 to couple to a memory bus that can be the DRAM bus 118. I/O interface logic 522 (as well as I/O interface logic 542 of memory device 104) can include pins, pads, connectors, signal lines, traces, or wires, or other hardware to connect the devices, or a combination of these. I/O interface logic 522 can include a hardware interface. As illustrated, I/O interface logic 522 includes at least drivers/transceivers for signal lines. Commonly, wires within an integrated circuit interface couple with a pad, pin, or connector to interface signal lines or traces or other wires between devices. I/O interface logic 522 can include drivers, receivers, transceivers, or termination, or other circuitry or combinations of circuitry to exchange signals on the signal lines between the devices.

The exchange of signals includes at least one of transmit or receive. While shown as coupling I/O interface logic 522 from memory controller 128 to I/O interface logic 542 of memory device 104, it will be understood that in an implementation of system 500 where groups of memory devices 104 are accessed in parallel, multiple memory devices can include I/O interfaces to the same interface of memory controller 128. In an implementation of system 500 including one or more memory modules 100, I/O interface logic 542 can include interface hardware of the memory module in addition to interface hardware on the memory device itself. Other memory controllers 128 can include separate interfaces to other memory devices 104.

The bus between memory controller 128 and memory devices 104 can be a double data rate (DDR) high-speed DRAM interface to transfer data that is implemented as multiple signal lines coupling memory controller 128 to memory devices 104. The bus may typically include at least clock (CLK) 532, command/address (CMD) 534, and data (write data (DQ) and read data (DQO) 536, and zero or more control signal lines in control 538. The bus can include sideband (SB) signals. In some examples, SB signals may include a SB clock and SB data signal. For instance, in some embodiments SB signals comprises an I2C or I3C bus. Optionally, other existing or future sideband signals may be used.

In one embodiment, a bus or connection between memory controller 128 and memory can be referred to as a memory bus. The signal lines for CMD can be referred to as a “C/A bus” (or ADD/CMD bus, or some other designation indicating the transfer of commands (C or CMD) and address (A or ADD) information) and the signal lines for data (write DQ and read DQ) can be referred to as a “data bus.” It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 128 and memory devices 104. An example of a serial bus technology is 8B10B encoding and transmission of high-speed data with embedded clock over a single differential pair of signals in each direction.

In one embodiment, one or more of CLK 532, CMD 534, Data 536, or control 538 can be routed to memory devices 104 through logic 580. Logic 580 can be or include a register or buffer circuit. Logic 580 can reduce the loading on the interface to I/O interface 522, which allows faster signaling or reduced errors or both. The reduced loading can be because I/O interface 522 sees only the termination of one or more signals at logic 580, instead of termination of the signal lines at every one or memory devices 104 in parallel. While I/O interface logic 542 is not specifically illustrated to include drivers or transceivers, it will be understood that I/O interface logic 542 includes hardware necessary to couple to the signal lines. Additionally, for purposes of simplicity in illustrations, I/O interface logic 542 does not illustrate all signals corresponding to what is shown with respect to I/O interface 522. In one embodiment, all signals of I/O interface 522 have counterparts at I/O interface logic 542. Some or all of the signal lines interfacing I/O interface logic 542 can be provided from logic 580. In one embodiment, certain signals from I/O interface 522 do not directly couple to I/O interface logic 542, but couple through logic 580, while one or more other signals may directly couple to I/O interface logic 542 from I/O interface 522 via I/O interface 572, but without being buffered through logic 580. Signals 582 represent the signals that interface with memory devices 104 through logic 580.

It will be understood that in the example of system 500, the bus between memory controller 128 and memory devices 104 includes a subsidiary command bus CMD 534 and a subsidiary data bus 536. In one embodiment, the subsidiary data bus 536 can include bidirectional lines for read data and for write/command data. In another embodiment, the subsidiary data bus 536 can include unidirectional write signal lines for write and data from the host to memory, and can include unidirectional lines for read data from the memory device 104 to the host. In accordance with the chosen memory technology and system design, control signals in control 538 may accompany a bus or sub bus, such as strobe lines DQS. Based on design of system 500, or implementation if a design supports multiple implementations, the data bus can have more or less bandwidth per memory device 104. For example, the data bus can support memory devices 104 that have either a x32 interface, a x16 interface, a x8 interface, or another interface. The convention “xW,” where W is an integer that refers to an interface size or width of the interface of memory device 104, which represents a number of signal lines to exchange data with memory controller 128. The number is often binary, but is not so limited. The interface size of the memory devices is a controlling factor on how many memory devices can be used concurrently in system 500 or coupled in parallel to the same signal lines. In one embodiment, high bandwidth memory devices, wide interface devices, or stacked memory configurations, or combinations, can enable wider interfaces, such as a x128 interface, a x256 interface, a x512 interface, a x1024 interface, or other data bus interface width.

Memory devices 104 represent memory resources for system 500. In one embodiment, each memory device 104 is a separate memory die. Each memory device 104 includes I/O interface logic 542, which has a bandwidth determined by the implementation of the device (e.g., x16 or x8 or some other interface bandwidth). I/O interface logic 542 enables each memory device 104 to interface with memory controller 128. I/O interface logic 542 can include a hardware interface, and can be in accordance with I/O interface logic 522 of memory controller 128, but at the memory device end. In one embodiment, multiple memory devices 104 are connected in parallel to the same command and data buses. In another embodiment, multiple memory devices 104 are connected in parallel to the same command bus, and are connected to different data buses. For example, system 500 can be configured with multiple memory devices 104 coupled in parallel, with each memory device responding to a command, and accessing memory resources 560 internal to each. For a write operation, an individual memory device 104 can write a portion of the overall data word, and for a read operation, an individual memory device 104 can fetch a portion of the overall data word. As non-limiting examples, a specific memory device can provide or receive, respectively, 8 bits of a 128-bit data word for a Read or Write transaction, or 8 bits or 16 bits (depending for a x8 or a x16 device) of a 256-bit data word. The remaining bits of the word are provided or received by other memory devices in parallel.

In one embodiment, memory devices 104 can be organized into memory modules 100. In one embodiment, memory modules 100 represent dual inline memory modules (DIMMs). Memory modules 100 can include multiple memory devices 104, and the memory modules can include support for multiple separate channels to the included memory devices disposed on them.

Memory devices 104 each include memory resources 560. Memory resources 560 represent individual arrays of memory locations or storage locations for data. Typically, memory resources 560 are managed as rows of data, accessed via word line (rows) and bit line (individual bits within a row) control. Memory resources 560 can be organized as separate banks of memory. Banks may refer to arrays of memory locations within a memory device 104. In one embodiment, banks of memory are divided into sub-banks with at least a portion of shared circuitry (e.g., drivers, signal lines, control logic) for the sub-banks.

In one embodiment, memory devices 104 include one or more registers 544. Register 544 represents one or more storage devices or storage locations that provide configuration or settings for the operation of the memory device. In one embodiment, register 544 can provide a storage location for memory device 104 to store data for access by memory controller 128 as part of a control or management operation. In one embodiment, register 544 includes one or more Mode Registers. In one embodiment, register 544 includes one or more multipurpose registers. The configuration of locations within register 544 can configure the memory device 104 to operate in different “mode,” where command information can trigger different operations within memory device 104 based on the mode. Additionally, or in the alternative, different modes can also trigger different operation from address information or other signal lines depending on the mode. Settings of register 544 can indicate configuration for I/O settings (e.g., timing, termination, driver configuration, or other I/O settings).

Memory controller 128 includes scheduler 530, which represents logic or circuitry to generate and order transactions to send to memory device 104. From one perspective, the primary function of memory controller 128 is to schedule memory access and other transactions to memory device 104. Such scheduling can include generating the transactions themselves to implement the requests for data by processor 510 and to maintain integrity of the data (e.g., such as with commands related to refresh).

Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 128 typically includes logic to allow selection and ordering of transactions to improve performance of system 500. Thus, memory controller 128 can select which of the outstanding transactions should be sent to memory device 104 in which order, which is typically achieved with logic much more complex than a simple first-in first-out algorithm. Memory controller 128 manages the transmission of the transactions to memory device 104, and manages the timing associated with the transaction. In one embodiment, transactions have deterministic timing, which can be managed by memory controller 128 and used in determining how to schedule the transactions.

Referring again to memory controller 128, memory controller 128 includes command (CMD) logic 524, which represents logic or circuitry to generate commands to send to memory devices 104. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 104, memory controller 128 can issue commands via I/O 522 to cause the memory device 104 to execute the commands. Memory controller 128 can implement compliance with standards or specifications by access scheduling and control.

Referring again to logic 580, in one embodiment, logic 580 buffers signals 582 from the host to memory devices 104. In one embodiment, logic 580 buffers data signal lines 536 as data 586, and buffers command (or command and address) lines of CMD 534 as CMD 584. In one embodiment, data 586 is buffered, but includes the same number of signal lines as data 536. Thus, both are illustrated as having X signal lines. In contrast, CMD 534 has fewer signal lines than CMD 584. Thus, P>N. The N signal lines of CMD 534 are operated at a data rate that is higher than the P signal lines of CMD 584. For example, P can equal 2N, and CMD 584 can be operated at a data rate of half the data rate of CMD 534.

In one embodiment, memory controller 128 includes refresh logic 526. Refresh logic 526 can be used for memory resources 560 that are volatile and need to be refreshed to retain a deterministic state. In one embodiment, refresh logic 526 indicates a location for refresh, and a type of refresh to perform. Refresh logic 526 can execute external refreshes by sending refresh commands. For example, in one embodiment, system 500 supports all bank refreshes as well as per bank refreshes. All bank refreshes cause the refreshing of a selected bank 592 within all memory devices 104 coupled in parallel. Per bank refreshes cause the refreshing of a specified bank 592 within a specified memory device 104.

Memory controller 128 further includes a sideband bus controller 528 that provides control input to the memory module 100 via sideband signals.

System 500 can include a memory circuit, which can be or include logic 580. To the extent that the circuit is considered to be logic 580, it can refer to a circuit or component (such as one or more discrete elements, or one or more elements of a logic chip package) that buffers the command bus. To the extent the circuit is considered to include logic 580, the circuit can include the pins of packaging of the one or more components, and may include the signal lines. The memory circuit includes an interface to the N signal lines of CMD 534, which are to be operated at a first data rate. The N signal lines of CMD 534 are host-facing with respect to logic 580. The memory circuit can also include an interface to the P signal lines of CMD 584, which are to be operated at a second data rate lower than the first data rate. The P signal lines of CMD 584 are memory-facing with respect to logic 580. Logic 580 can either be considered to be the control logic that receives the command signals and provides them to the memory devices, or can include control logic within it (e.g., its processing elements or logic core) that receive the command signals and provide them to the memory devices.

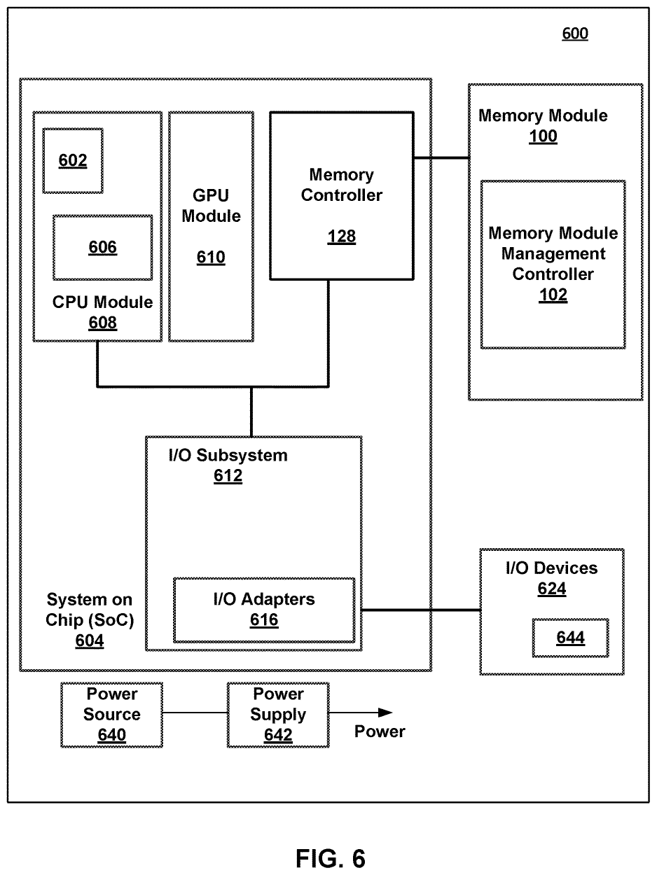

FIG. 6 is a block diagram of an embodiment of a computer system 600 that includes the memory module 100 that includes the memory module management controller 102 shown in FIG. 1. Computer system 600 can correspond to a computing device including, but not limited to, a server, a workstation computer, a desktop computer, a laptop computer, and/or a tablet computer.

The computer system 600 includes a system on chip (SOC or SoC) 604 which combines processor, graphics, memory, and Input/Output (I/O) control logic into one SoC package. The SoC 604 includes at least one Central Processing Unit (CPU) module 608, a memory controller 128, and a Graphics Processor Unit (GPU) 610. In other embodiments, the memory controller 128 can be external to the SoC 604. The CPU module 608 includes at least one processor core 602, and a level 2 (L2) cache 606.

Although not shown, each of the processor core(s) 602 can internally include one or more instruction/data caches, execution units, prefetch buffers, instruction queues, branch address calculation units, instruction decoders, floating point units, retirement units, etc. The CPU module 608 can correspond to a single core or a multicore general purpose processor, such as those provided by Intel® Corporation, according to one embodiment.

The Graphics Processor Unit (GPU) 610 can include one or more GPU cores and a GPU cache which can store graphics related data for the GPU core. The GPU core can internally include one or more execution units and one or more instruction and data caches. Additionally, the Graphics Processor Unit (GPU) 610 can contain other graphics logic units that are not shown in FIG. 6, such as one or more vertex processing units, rasterization units, media processing units, and codecs.

Within the I/O subsystem 612, one or more I/O adapter(s) 616 are present to translate a host communication protocol utilized within the processor core(s) 602 to a protocol compatible with particular I/O devices. Some of the protocols that adapters can be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 616 can communicate with external I/O devices 624 which can include, for example, user interface device(s) including a display and/or a touch-screen display 644, printer, keypad, keyboard, communication logic, wired and/or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The storage devices can be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)). The display 644 to display data stored in the plurality of memory devices in the memory module 100.

Additionally, there can be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

Power source 640 provides power to the components of computer system 600. More specifically, power source 640 typically interfaces to one or multiple power supplies 642 in computer system 600 to provide power to the components of computer system 600. In one example, power supply 642 includes an AC to DC (alternating current to direct current) adapter to plug into a wall outlet. Such AC power can be renewable energy (e.g., solar power) power source 640. In one example, power source 640 includes a DC power source, such as an external AC to DC converter. In one example, power source 640 or power supply 642 includes wireless charging hardware to charge via proximity to a charging field. In one example, power source 640 can include an internal battery or fuel cell source.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. A computing device comprising:
a memory controller coupled to processing circuitry; and
a dual in-line memory module (DIMM) coupled to the memory controller, wherein the memory controller is configured to:
assert a sideband reset condition, wherein assertion of the sideband reset condition resets at least one of a Power Management Integrated Circuit (PMIC), a first thermal sensor (TS0), a second thermal sensor (TS1), or sideband bus logic on the DIMM without resetting memory devices.

2. The computing device of claim 1, wherein the memory devices comprise Double Data Rate 5 (DDR5) Dynamic Random Access Memory (DRAM) devices on a memory module.

3. The computing device of claim 1, wherein the DIMM includes a Registering Clock Driver (RCD) coupled to the memory devices, wherein the RCD is configured to generate a reset signal to reset the memory devices independently of the sidebar reset condition.

4. The computing device of claim 1, wherein the DIMM comprises one or more of the PMIC, a data buffer coupled to the memory controller and the memory devices, or a sideband bus that is compliant with a DDR5 module sideband protocol, wherein the TS0 or the TS1 to measure a temperature relating to the memory devices on the memory module.

5. The computing device of claim 1, wherein the processing circuitry comprises application processing circuitry or graphics processing circuitry.

6. A memory device comprising:
a memory controller; and
a dual in-line memory module (DIMM) coupled to the memory controller, wherein the memory controller is configured to:
assert a sideband reset condition, wherein assertion of the sideband reset condition resets at least one of a Power Management Integrated Circuit (PMIC), a first thermal sensor (TS0), a second thermal sensor (TS1), or sideband bus logic on the DIMM without resetting memory devices.

7. The memory device of claim 6, wherein the memory devices comprise Double Data Rate 5 (DDR5) Dynamic Random Access Memory (DRAM) devices on a memory module.

8. The memory device of claim 6, wherein the DIMM includes a Registering Clock Driver (RCD) coupled to the memory devices, wherein the RCD is configured to generate a reset signal to reset the memory devices independently of the sidebar reset condition.

9. The memory device of claim 6, wherein the DIMM comprises one or more of the PMIC, a data buffer coupled to the memory controller and the memory devices, or a sideband bus that is compliant with a DDR5 module sideband protocol, wherein the TS0 or the TS1 to measure a temperature relating to the memory devices on the memory module.

10. The memory device of claim 6, wherein the memory controller is coupled to processing circuitry, the processing circuitry comprising application processing circuitry or graphics processing circuitry.
